(19) United States
(12) Patent Application Publication
(10) Pub. No.: US 2016/0098665 A1
(43) Pub. Date: Apr. 7, 2016

(54) FLOWING SKILL REQUEST VECTORS TO WORKFORCE HIRING TOOLS

(71) Applicant: Avaya Inc., Santa Clara, CA (US)

(72) Inventors: David Skiba, Golden, CO (US); Valentine C. Matula, Granville, OH (US); George Erhart, Loveland, CO (US)

(21) Appl. No.: 14/504,273

(22) Filed: Oct. 1, 2014

(51) Int. Cl. G06Q 10/06

(52) U.S. Cl. CPC G06Q 10/063112

(57) ABSTRACT

Systems are provided for the automatic analysis of skills in a contact center. More particularly to skills that are available, skills that are requested, and the difference between the two. The system may then determine a number of solutions that, if implemented by the contact center, would allow the contact center to have the skill differential. A decision is then made whereby a factor is utilized to select the more optimal solution from the number of solutions.

### FIELD OF THE DISCLOSURE

The present disclosure is generally directed toward the management of contact center resources.

### BACKGROUND

Workforce management has focused on the data made available from accounting systems. Human resources (HR) effectiveness is measured using personnel metrics, such as absence rate (absenteeism), cost per hire (CPH), and turnover and performance metrics, such as customer satisfaction, process effectiveness, and employee development, and when available, financial performance. HR metrics and analytics typically comprise some type of information system. Like all information systems, they are useful only if managers are enabled to make different and ideally better decisions than they would have without the information.

### SUMMARY

It is with respect to the above issues and other problems that the embodiments presented herein were contemplated.

With regard to certain embodiments disclosed herein, workforce hiring tools benefit from the addition of information compiled from matches made by a work assignment engine (WAE) of a contact center. Rather than relying on dashboards, benchmarking, and data mining asking the following questions (Are you able to attract and hire the sales candidates you want? Have you been equally successful in hiring male and female candidates? Are you losing top performers?), embodiments disclosed herein enable automatic tactical choices. Using information from a WAE, embodiments herein enable the flow of “skill request vectors” to workforce hiring tools.

In one embodiment, a WAE is provided that can produce data, such as data indicating request for certain agent skill combinations, degree of match success for the requested combination against a current agent pool, and then perform the following:

1. Identify key skills requested, and thus identify those missing skills.

2. Perform optimization of who to hire (i.e., skills to hire) based on costs associated to train new hires, anticipated salary levels, % efficiency while ramping up effectiveness, willingness to work part time shifts, etc.

3. Calculate who to remove from the business based on (assumed lower) performance and mix of skills. The calculation may include termination expenses, such as severance costs.

4. Calculate normal staff churn, such as from historic records, to promote the hiring of personnel ahead of the anticipated unannounced departures of those being replaced.

5. Identify those individuals with critical skills or skill mixes for salary increases, retention programs, promotions, bonuses, and/or other retention incentives.

6. Identify “up and comers,” who have one or more skills or mix of skills that are not yet optimal, for adding and/or enhancing skills. Skills may be graded by their ability to learn, which may be further based on the presence of other skills. For example, familiarity with Ohio insurance laws might be fairly easy to learn for one already knowledgeable in Pennsylvania insurance law, but learning Vietnamese may be impractical.

7. Identify the value to the business to offer on-the-job paid training for certain skills, such as those that have a lower associated costs compared to the cost associated to hire individuals already having those skills and/or likely hiring/retention rates over new hires for target skill mixes.

It should be noted that the order, addition, and/or omission of certain steps identified above may be made without departing from the scope of the disclosure provided herein.

As a benefit of one or more embodiments described herein, information may be automatically provided regarding who to hire, how many to hire, and who and how many to dismiss based on performance and/or mismatched skill sets, enhancing the ability of the contact center to secure the combination of the right skills in the market and/or conduct hiring at the right price level. Furthermore, salary level can be included as part of the calculations and determinations disclosed herein. However, legal compliance may prohibit and/or require modification of certain aspects disclosed herein associated with the gathering, storing, processing, and/or using salary and/or other data.

In one embodiment, an automated workforce management system is disclosed, comprising: a work assignment engine of a contact center comprising an output; and a processor configured to: access, from the output, a requested skill for a work item and a selected skill for the work item; derive a skill differential from the requested skill and the selected skill; derive a plurality of solutions to provide the skill differential; access a factor to optimize; select one of the plurality of solutions in accord with the factor; and report the selected one of the plurality of solutions.

In another embodiment, an automated workforce management system is disclosed, comprising: a work assignment engine of a contact center comprising an output; and a microprocessor configured to: access, from the output, a selected skill to process a work item wherein the selected skill has an estimated attrition rate; select a substitute skill to be utilized for processing the work items requesting the selected skill in the absence of the selected skill; access a factor to optimize; select one of the plurality of solutions in accord with the factor; and report the selected one of the plurality of solutions.

In yet another embodiment, an automated workforce management system is disclosed, comprising: a work assignment engine of a contact center comprising an output; and a processor configured to: access, from the output, a selected skill to process a work item wherein the selected skill has an estimated attrition rate; select a substitute skill to be utilized for processing the work items requesting the selected skill in the absence of the selected skill; select an agent having the substitute still and not having the selected skill; accessing a factor to optimize; select one of the plurality of solutions in accord with the factor; and report the selected one of the plurality of solutions.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a communication system in accordance with embodiments of the present disclosure;

FIG. 2 depicts a data flow diagram in accordance with at least some embodiments of the present disclosure;

FIG. 3 depicts a process in accordance with at least some embodiments of the present disclosure;

FIG. 4 depicts a first flow diagram in accordance with at least some embodiments of the present disclosure; and

FIG. 5 depicts a second flow diagram in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

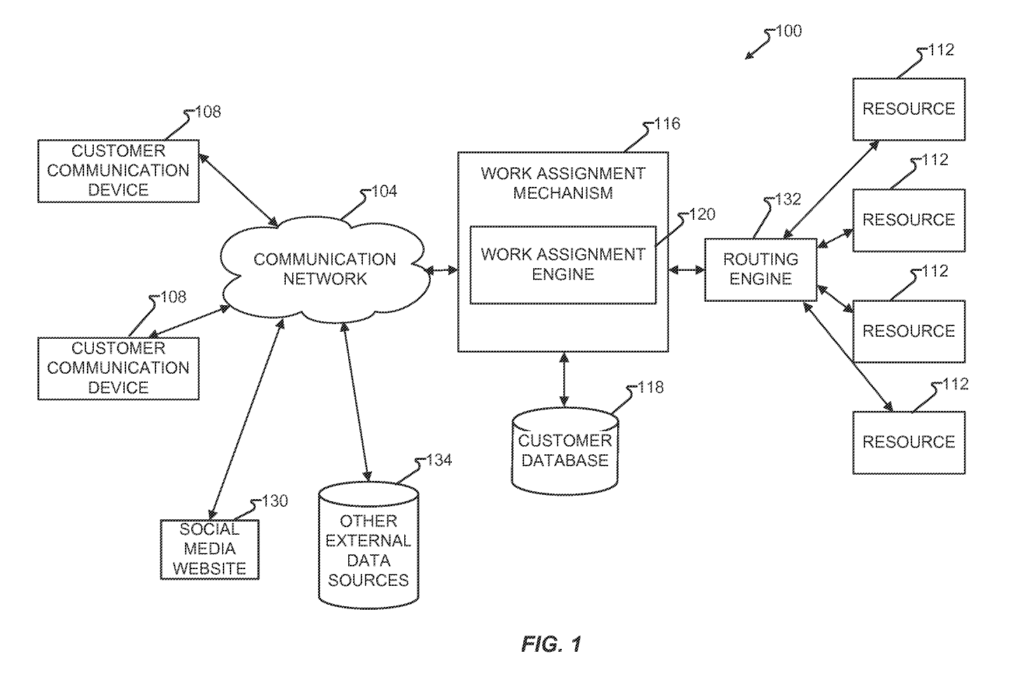

FIG. 1 shows an illustrative communication system 100 in accordance with at least some embodiments of the present disclosure

With reference now to FIG. 1, communication system 100 in accordance with at least some embodiments of the present disclosure. The communication system 100 may be a distributed system and, in some embodiments, comprises a communication network 104 connecting one or more communication devices 108 to a work assignment mechanism 116, which may be owned and operated by an enterprise administering a contact center in which a plurality of resources 112 are distributed to handle incoming work items (in the form of contacts) from customer communication devices 108. Additionally, social media website 130 may be utilized to provide one means for a resource 112 to receive and/or retrieve contacts and connect to a customer of a contact center. Customers may utilize their respective customer communication device 108 to send/receive communications utilizing social media website 130.

In accordance with at least some embodiments of the present disclosure, the communication network 104 may comprise any type of known communication medium or collection of communication media and may use any type of protocols to transport messages between endpoints. The communication network 104 may include wired and/or wireless communication technologies. The Internet is an example of the communication network 104 that constitutes and Internet Protocol (IP) network consisting of many computers, computing networks, and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 104 need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application No. 12/469,523 to Steiner, the entire contents of which are hereby incorporated herein by reference. Moreover, the communication network 104 may comprise a number of different communication media such as coaxial cable, copper cable/wire, fiber-optic cable, antennas for transmitting/receiving wireless messages, and combinations thereof

The communication devices 108 may correspond to customer communication devices. In accordance with at least some embodiments of the present disclosure, a customer may utilize their communication device 108 to initiate a work item, which is generally a request for a processing resource 112. Illustrative work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 116, but rather may be on some other server in the communication network 104 where it is harvested by the work assignment mechanism 116, which generates a work item for the harvested communication, such as social media server 130. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 is assigned to the work item representing that communication at which point the work assignment mechanism 116 passes the work item to a routing engine 132 to connect the communication device 108 which initiated the communication with the assigned resource 112.

Although the routing engine 132 is depicted as being separate from the work assignment mechanism 116, the routing engine 132 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112. The type of medium used by the communication device 108 to communicate with other communication devices 108 or processing resources 112 may depend upon the communication applications available on the communication device 108.

In accordance with at least some embodiments of the present disclosure, the work item is sent toward a collection of processing resources 112 via the combined efforts of the work assignment mechanism 116 and routing engine 132. The resources 112 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. In some embodiments, the work assignment mechanism 116 may be administered by multiple enterprises, each of which has their own dedicated resources 112 connected to the work assignment mechanism 116.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. In other embodiments, the work assignment engine 120 may be configured to execute work assignment decisions in a traditional queue-based (or skill-based) contact center.

The work assignment engine 120 and its various components may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In one embodiment, a message is generated by customer communication device 108 and received, via communication network 104, at work assignment mechanism 116. The message received by a contact center, such as at the work assignment mechanism 116, is generally, and herein, referred to as a “contact.” Routing engine 132 routes the contact to at least one of resources 112 for processing.

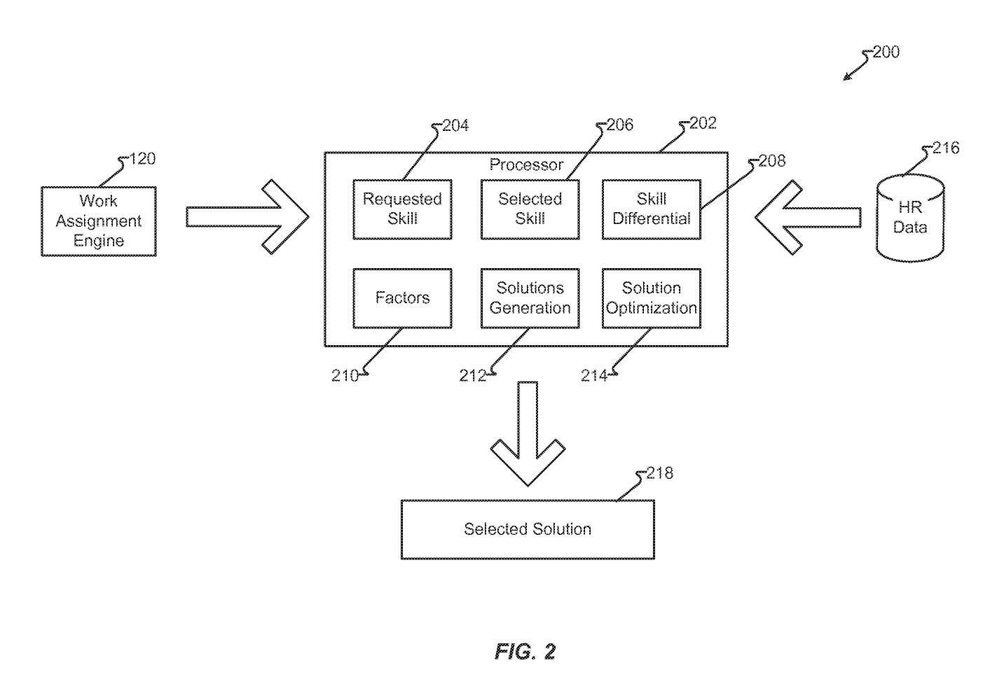

With reference now to FIG. 2, data flow diagram 200 is described in accordance with at least some embodiments of the present disclosure. In one embodiment, processor 202 is one or more components of one or more components of communication system 100. In a further embodiment, processor 202 is a processor on work assignment mechanism 116, work assignment engine 120, routing engine 132, and/or other dedicated or shared processor or number of processors.

In one simplified embodiment, processor 202 receives the output of work assignment engine 120 and, optionally HR database 216 to determine one or more skills of an agent (e.g., one of resources 112). Processor 202 then provides a selected solution 218 such as to another system, for automatic execution, and/or to a human operator for approval and/or manual execution.

Processor 202 is configured to determine a requested skill for a work item. As can be appreciated by those of ordinary skill in the art, a plurality of work items, even a very large number of work items, may be utilized in place of a single work item without departing from the disclosure provided herein. A work item can have a requested skill (e.g., expert in Indiana insurance law, fluent in Spanish, etc.) associated with an agent. A work item may also have selected skill 206, such as by routing engine 132 selecting one of agent 112 that is believed to have skills to process a work item even if the agent 112 does not have requested skill 204 (e.g., selecting an agent that is an expert in Illinois insurance law, competent in Spanish, etc.). Skill differential 208 may be a differential between requested skill 204 and selected skill 206. For example, agent 112 may have selected skill 206 of expertise in Illinois insurance law for a work item having requested skill 204 of expertise in Indiana insurance law, however, as there may be substantial overlap skill differential 208 may be one or more specific items, such as, agent 112 does not have Indiana probate law knowledge.

Skill differential 208 may reflect a degree within the same skill. For example, certain skill competence may be measured by duration. For example, requested skill 204 may be ten years of German fluency, selected skill 206 may be six years of German fluency, and therefore skill differential 208 is four years of German fluency.

Skill differential 208 may represent a skill that is not on staff (e.g., no German speaking agents 112 exist), no agents 112 are available to accept the item, etc. In addition, skill differential 208 may represent an oversubscribed skill. For example, there may be a number of German speaking agents 112, however, the volume of German work items may result in the German speaking agents 112 being assigned to non-German work items. As a result, skill differential 208 may indicate a skill to increase via hiring and/or training or reduce. Furthermore, hiring and/or training programs may be reduced or eliminated. Continuing the example, if German agents 112 are not being fully utilized, not hiring German speaking agents 112 and/or not training additional agents 112 to become fluent in German may be a first, or perhaps only, step necessary to reduce skill differential 112. The number of German speaking agents 112 may be maintained or with agent 112 “churn,” the number be reduced. As an alternative or additional step, agents 112 speaking German may be retrained in other areas (e.g., languages, products, technologies, etc.) or terminated to reduce the skill differential 208.

In another embodiment, the mix of skills has a value different than the sum of the individual skill values. For example, one agent 112 may have expertise in Indiana insurance law and another agent 112 may be fluent in Spanish, however, a more ideal agent 112 would have both fluency in Spanish and expertise in Indiana insurance law. Accordingly, requested skill 204 is fluent Spanish/expert insurance, selected skill 206 may be nearly any combination degrees of non-fluent Spanish/non-expert insurance, and skill differential 208 being that which would take agent 112 to become fluent Spanish/expert insurance.

In another embodiment, skill differential 208 may be different from both requested skill 204 and selected skill 206. Certain skills may be predictive of the ability for another individual to learn another skill. For example, selected skill 206 may be statistics and requested skill 204 may be calculus, skill differential 208 may then be linear algebra. One solution may be to teach linear algebra to an agent 112 with statistics expertise.

In another embodiment, solutions generation 212 generates a number of solutions that would provide requested skill 204. One of agent 112 may be trained to acquire skill differential 208, a new agent may be hired who already has skill differential 208, and or a combination thereof. Factor 210 is a weighted priority of dimensions of time, money, and/or other resources associated with providing skill differential 208.

The actual or planned net impact on a contact center for adding skill differential 208 includes adding an otherwise skill differential, adding a skill available in deficient quantity, anticipating the loss of skill differential 208 and hiring and/or training to maintain skill differential 208. Furthermore, while the addition of skills to provide growth and/or maintenance of a quantity of the skill may also apply to negative growth. For example requested skill 204 may be basic knowledge (e.g., an obsolete or waning product or service), selected skill 206 may be expertise in the skill, and skill differential 208 may then be a negative amount of skill in the area. Solution generation 212 may then determine the cost to retrain or terminate an agent 112 having expertise in the skill.

Solution optimization 214 is configured to select a previously determined number, such as one, solution in accord with solutions generated by solutions generation 212 and factors 210. As a result, selected solution 218 is produced for automatic execution, human execution, and/or human review.

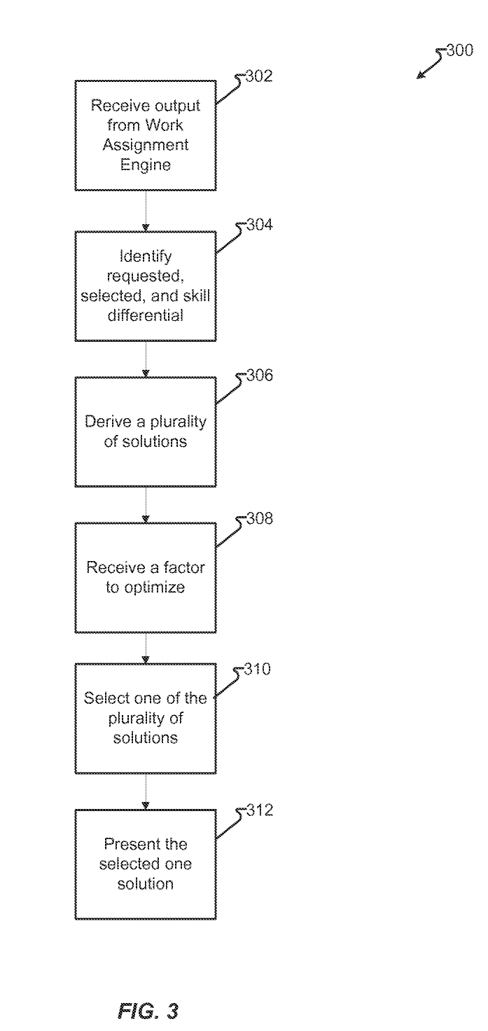

With reference now to FIG. 3, process 300 is described in accordance with at least some embodiments of the present disclosure. In one embodiment, step 302 receives the output from work assignment engine 120. Step 304 then analyzes the output of work assignment engine 120 to determine a requested skill 204, selected skill 206, skill differential 208. Step 306 derives a plurality of solutions whereby skill differential 208 may be provided to the contact center. Step 308 receives a factor which may be one or more of time, money, human resource, disruption, or other business aspect that may be affected. Step 310 then selects one of the plurality of solutions and step 312 presents the selected one solution.

In another embodiment, the resource may have a positive or negative effect on the contact center, such as one based on historical information. For example, hiring a new agent has an associated money cost (e.g., agency fees, non-productive orientation time, etc.). Similarly, terminating an employee may have severance, processing fees, risk of legal action, etc. The time, allocation of other personnel, time spent coming up to speed in some aspect of being an agent, etc., may each be considered and weighed for selection by step 310 in accord with the factor.

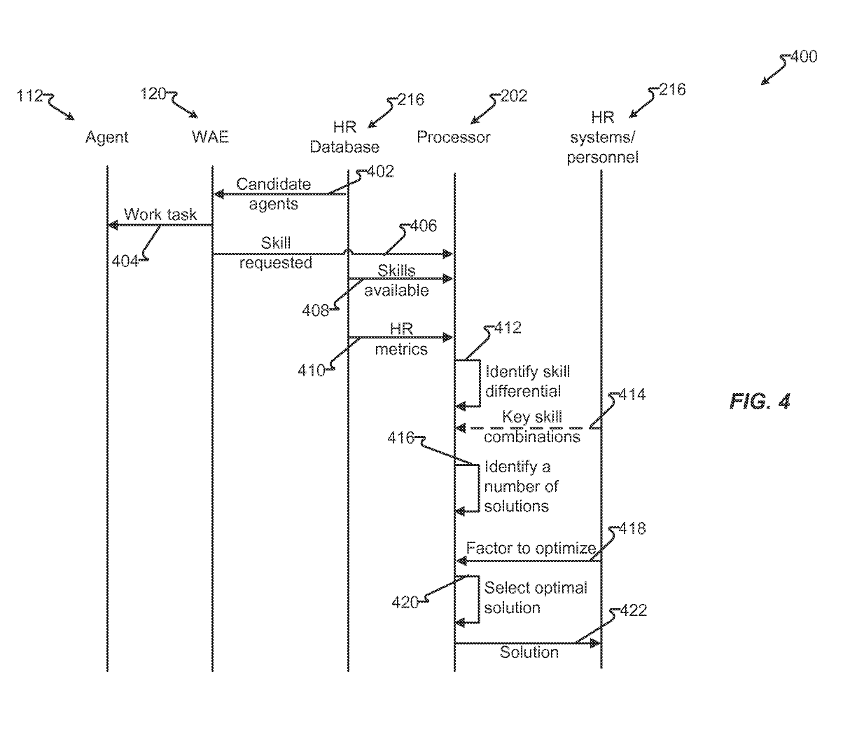

With reference now to FIG. 4, flow diagram 400 is described in accordance with at least some embodiments of the present disclosure. In one embodiment, human resource database (HR Database) 216 provides data to work assignment engine (WAE) 120 comprising candidate agents 402 for one or more work tasks (e.g., work task 404 or work tasks including work task 404). WAE 120 assigns work task 404 to agent 112, such as by executing an agent selecting algorithm.

WAE 120 provides skill requested 406 to processor 202. Skill requested 406 may be any one or more measured aspects of task 404, such as having a particular skill, having a particular proficiency level with respect to a skill, having a combination of certain skills, etc. Skills available 408 may also be provided by HR database 216 to processor 202 with respect to one or more agents 112. HR database 216 may also provide HR metrics 410 to processor 202, such as the cost to hire a new agent 112, cost to train agent 112 having a first skill to have a second skill, cost to terminate agent 112, cost to lose agent 112 based on predicted “churn” of agents, cost to replace agent 112, cost of incentives design to retain agent 112, etc. Cost includes the financial outlay, cost of other resources (e.g., human and non-human resources that are allocated to training), time, customer satisfaction, and/or other monetary and non-monetary expenditures. Costs are not limited to expenditures but may also include savings or earned benefits which may be financial (e.g., hiring a particular agent allowing the contact center to accept more high-paying tasks, improve response time, increase customer satisfaction, etc.).

Processor 202 indentifies one or more skill differentials 412. Skill differentials 412 may be the difference between skill requested 406 and skills available 408. Optionally, key skill combinations 414 may be provided, such as by HR systems/personnel 216. Processor 202 identifies a number of solutions directed towards mitigating or eliminating skill differentials. HR systems/personnel 216 may provide one or more factors to optimize, order of optimization, conditional optimizations, or other optimization factors. Processor 420 determines and selects an optimal solution form the identified number of solutions 416 and provides solutions 422 to HR systems/personnel 216 for review and/or execution, such as a work force planning module.

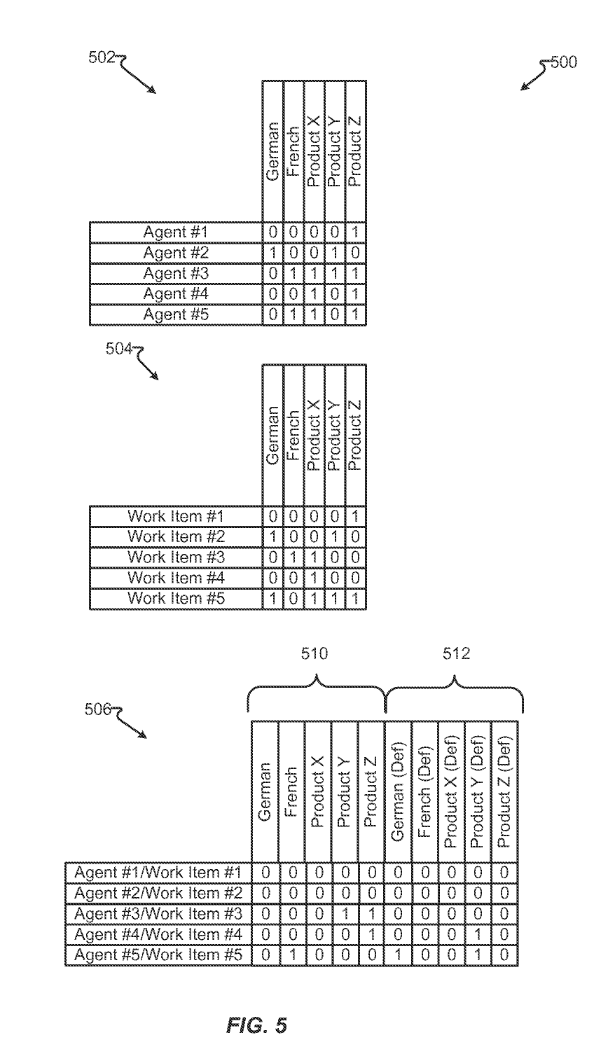

With reference now to FIG. 5, flow diagram 500 is described in accordance with at least some embodiments of the present disclosure. In one embodiment, table 502 provides a bitmap of skills available 408 for agent 112, table 504 provides a bitmap of the skills requested 405 for various work items, and table 506 provides a bitmap of skill differentials 412. Table 506 may form a number of vectors that may further be provided to the HR systems 216, such as a work force management planning module.

It should be appreciated that a bitmap illustrated is one data representation and that other data representations may be provided, such as triples, structures, values, etc. without departing from the disclosure provided herein. Attributes 510 and/or 512 thereby provide a ready indication of whether a skill has been requested and supplied, requested but not supplied, and/or not requested but supplied. In another embodiment, more complex data structures, for example a data structure operable to indicate the shortage, overage, or zero value for skill differential 208 may also be provided such that the values of attribute 510 and 512 may be provided with a single data element.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An automated workforce management system, comprising:
a work assignment engine of a contact center comprising an output; and
a processor configured to:
access, from the output, a requested skill for a work item and a selected skill for the work item;
derive a skill differential based on the requested skill and the selected skill;
derive a plurality of solutions to provide the skill differential to at least one of the contact center and an agent within the contact center;
access a factor to optimize;
select one of the plurality of solutions in accord with the factor; and
report the selected one of the plurality of solutions.

2. The system of claim 1, wherein the processor is further configured to derive at least one of the plurality of solutions based on a resource estimated to hire a first candidate having the skill differential.

3. The system of claim 2, wherein the processor is further configured to derive at least one of the plurality of solutions based on a resource estimated to hire a second candidate having the skill differential.

4. The system of claim 1, wherein the processor is further configured to derive at least one of the plurality of solutions based on a resource estimated to train an agent of the contact center cause the agent to acquire the skill differential.

5. The system of claim 4, wherein the processor is further configured to access at least one predicting skill associated with the skill differential and determine the resource to train the agent to acquire the skill differential with the agent having the predicting skill.

6. The system of claim 5, wherein the processor is further configured to determine the resource to include the benefit of the agent having the skill differential and the predicting skill.

7. The system of claim 6, wherein the benefit of the predicting skill and the skill differential is different than the sum of the benefit of the predicting skill and the sum of the skill differential.

8. The system of claim 4, wherein the resource is at least one trained agent having a work skill and a training skill and is unable, at least in part, to perform the work skill when assigned to perform the training skill.

9. An automated workforce management system, comprising:
a work assignment engine of a contact center comprising an output; and
a processor configured to:
access, from the output, a selected skill to process a work item wherein the selected skill has an estimated attrition rate;
select a substitute skill to be utilized for processing the work items requesting the selected skill in the absence of the selected skill;
access a factor to optimize;
select one of the plurality of solutions in accord with the factor; and
report the selected one of the plurality of solutions.

10. The system of claim 9, wherein the selected skill has an attrition rate further determined by a workforce reduction plan to reduce the selected skill.

11. The system of claim 9, wherein the processor is further configured to derive at least one of the plurality of solutions based on a resource estimated to hire a first candidate having the substitute skill.

12. The system of claim 9, wherein the processor is further configured to derive at least one of the plurality of solutions based on a resource estimated to train an agent of the contact center cause the agent to have the substitute skill.

13. The system of claim 12, wherein the agent has the selected skill.

14. The system of claim 9, wherein the processor is further configured to derive at least one of the plurality of solutions based on a resource estimated to terminate an agent of the contact center having the selected skill.

15. The system of claim 12, wherein the processor is further configured to access at least one predicting skill associated with the substitute skill and determine the resource to train the agent having the predicting still to acquire the substitute skill.

16. The system of claim 12, wherein the processor is further configured to derive at least one of the plurality of solutions based on a resource estimated to hire a new agent of the contact center having the selected skill, a time for the new agent to become operational, and the difference between the time the new agent becomes operational and the time estimated attrition will cause a need for the contact center to acquire the new agent.

17. The system of claim 12, wherein the processor is further configured to derive at least one of the plurality of solutions based on a resource estimated to train an agent of the contact center to acquire the selected skill, a time for the agent to become operational, and the difference between the time the agent to becomes operational with the selected skill and the time estimated attrition will cause a need for the contact center to have the agent operational wit the selected skill.

18. An automated workforce management system, comprising:
a work assignment engine of a contact center comprising an output; and
a processor configured to:
access, from the output, a selected skill to process a work item wherein the selected skill has an estimated attrition rate;
select a substitute skill to be utilized for processing the work items requesting the selected skill in the absence of the selected skill;
select an agent having the substitute still and not having the selected skill;
access a factor to optimize;
select one of the plurality of solutions in accord with the factor; and
report the selected one of the plurality of solutions.

19. The system of claim 18, wherein the processor is further configured to derive at least one of the plurality of solutions based on training the agent to acquire the selected skill wherein the substitute skill in combination with the selected skill has a value different than the sum of the value of the substitute skill and value of the selected skill.

20. The system of claim 19, wherein the processor is further configured to derive at least one of the plurality of solutions based on hiring a replacement agent having the selected skill.
